(19) United States
(12) Patent Application Publication
(10) Pub. No.: US 2011/0204645 A1
(43) Pub. Date: Aug. 25, 2011

(54) Hydropower system with reciprocal floatation device

(76) Inventor: Mark S. Jacobson, Flemington, NJ (US)

(21) Appl. No.: 12/660,187

(22) Filed: Feb. 22, 2010

(51) Int. Cl. F03B 13/08; F03B 17/04

(52) U.S. Cl. 290/54; 415/916

(57) ABSTRACT

A hydropower system generating electric power includes a circuitous loop for flow of liquid with: a) a liquid return conduit; b) at least one reservoir below the conduit outlet, with a dispenser for dispensing liquid from the reservoir to a plurality of displacement columns; c) displacement columns below the reservoir; d) controls and valves connected to the reservoir dispenser and displacement column for sequentially adding and removing liquid to and from the displacement column for upward floatation of the weight and corresponding float and for subsequent removal of liquid from the displacement column via gravitational force of the weight; e) weights within the displacement columns; f) floats connected to each weight; g) engagement mechanism for engaging the float to the weight for upward movement of the float and weight in rising liquid and disengagement of the float from the weight for removal of liquid from the displacement column via gravitational force.

### BACKGROUND OF INVENTION

a. Field of Invention

The invention relates generally to the creation/production of electric energy using hydro turbine technology. More particularly, the present invention utilizes reciprocal weights and floatation devices to lift the weights by rising water and then moving water in a continuous loop via gravity, with the weights, to operate one or more hydro turbines. There may be a series of weights that operate out of phase from one another to establish a continuous output arrangement.

b. Description of Related Art

The following patents are representative of the field pertaining to the present invention:

U.S. Pat. No. 7,584,609 B2 to Welch, Jr. et al. describes a system and method for generating electricity that includes converting wave motion into mechanical power. A fluid matter is driven as a function of the mechanical power to a reservoir. The fluid matter is flowed from the reservoir. At least a portion of a kinetic energy of the flowing fluid matter is converted into electrical energy. The fluid matter may be liquid or gas.

U.S. Pat. No. 7,222,487 B1 to Hinkley describes a wheel assembly with tangentially attached fluid receptacles around the perimeter that rotates to power a gravity driven fluid electricity generating assembly. A plunger pump assembly with a drive wheel powered by the wheel assembly pumps a quantity of fluid to fill a fluid receptacle with each motion of a lever arm eccentrically attached to the drive wheel.

U.S. Pat. No. 7,003,955 B2 to Davis describes an enhanced pumped storage power system. More particularly, the invention is a regenerative power system that utilizes the gravitational forces of downward movement of large quantities of water to convert same to electrical energy. In the preferred mode of implementation, the system utilizes a man-made lake at a first level of elevation. Though higher altitudes can be effective, the lake need only be approximately twenty to thirty feet in elevation. The lake, which may exceed one hundred acres in size, may be elevated above and adjacent a natural body of water, such as seawater at a coastline. As such, sandy terrain associated with the region facilitates initial construction of the system. An underground generator is utilized for the power conversion and pumping of the water back to the upper reservoir during times of low energy demand, allowing for significant noise reduction. Importantly, the system of the present invention may be utilized to provide significant levels of power to serve relatively large geographic areas during times of peak energy demand, when other sources of power are more expensive and subject to power outages. Finally, it should be noted that the components of the system are aesthetically-pleasing in nature, allowing the system to be effectively utilized in a residential area

U.S. Pat. No. 6,996,937 B2 to Halloran describes a system for generating electrical power using hydraulic supports on which a building structure is mounted. A pump injects fluid into the supports to raise the building structure and thereby store energy in the elevated structure. A valve can be opened to deliver fluid under pressure to a turbine or hydraulic motor driven generator to generate electricity.

U.S. Pat. No. 6,817,180 B2 to Newman describes a portable hydroelectric apparatus which converts the kinetic energy of water caused by gravity into electrical energy. This conversion is accomplished without the presence of a river or stream. A new type of buoyancy motor is disclosed which is formed as a U-tube erected vertically. One leg and the curved portion at the bottom are filled with a series of separate air-filled tanks. The other leg is filled with water, with a suitable seal at the bottom of the leg through which are made to jut 11/2 tanks so the seal prevents water from leaking downward into the air space of the curved portion of the U-tube. Suitable means prevent the water column in the one leg from pushing the series of tanks out of the U-tube. The leading as well as the succeeding tanks behind it are made buoyant in sequence. In rising through the water-filled leg of the U-tube water is pushed through a nozzle which is made to operate hydroelectric devices. Provision is made to recycle both the water and air-filled tanks.

U.S. Pat. No. 6,445,078 B1 to Cieslak Jr. describes a system for gravity generation of electricity which includes upper and lower water reservoirs with a conduit between the reservoirs and a pump to continuously pump water from the lower reservoir to the upper reservoir. A number of water containers are positioned side-by-side and mounted for up and down travel between the upper and lower reservoirs. When the containers have attained their upper most position at the upper reservoir, they are engaged by limit switch mechanisms to fill the containers with water from the upper reservoir. Upon being filled the containers travel by gravity to their lower most position to the lower reservoir wherein additional limit switch mechanisms are employed to drain the containers into the bottom reservoir. As the containers travel downwardly, they engage and drive an electric generator for generating large quantities of electricity. Once the containers are at their lower most position and have been fully drained they are driven back up to the upper reservoir for refill by independent geared motors.

U.S. Pat. No. 6,388,342 B1 to Vetterick, Sr. et al. describes an apparatus and method for converting renewable wave action energy to electrical energy that harnesses fluid wave power by employing a plurality of low-mass buoys floating on a fluid surface connected to low-volume pumps. The pumps transfer fluid from a source to an elevated storage tank. There, the water can be held in the tank as a reserve, when not being immediately used to generate electrical power. When there is a demand for electrical power, the reserve is released from the storage tank and flows, by gravity, through a hydro-electric generator creating an electrical current.

U.S. Pat. No. 5,430,333 to Binford et al. describes a plurality of inflation devices that are linked to one another to form a loop that is movably restrained so that a segment of the loop is disposed at a lower reference location at the given depth in a first body of water, another segment of the loop is disposed at an upper reference location situated above the lower reference location, another segment of the loop extends along a first path that extends generally upward from the lower reference location to the upper reference location, and another segment of the loop extends along a second path that extends generally parallel to the first path and upward from the lower reference location to the upper reference location. At least a majority of the inflation devices occupying the first path are inflated with gas and at least a majority of the inflation devices occupying the second path are deflated so that inflation devices in the first path move upward and inflation devices in the second path move downward. While each inflation device is proximate to the upper reference location, it is deflated by a compression facility that employs a differential temperature to controllably “stroke” Nitinol. The traveling or movement of the inflation devices is utilized to elevate water that flows, under the force of gravity, through a hydroelectric generating facility that generates electricity.

U.S. Pat. No. 4,100,743 to Trumbull et al. describes a gravity engine that converts one form of energy into another by using the expansion of a fluid medium to propel each of a plurality of bodies upwardly within one of a pair of adjacent vertical passageways. The expansion of a gas, such as steam supplied from a boiler heated by a solar panel, in a chamber and controlled by valves provides the force to propel the bodies against the force of gravity upwardly to the top of the first passageway. A guide directs the bodies from the top of the first passageway to the top of a second passageway wherein the bodies are stacked so that their combined weight acts upon a pocketed drive wheel at the bottom of the second passageway. The drive wheel is coupled to means such as an electrical generator to convert at least a portion of the potential energy of the stacked bodies into another form of energy. The pocketed wheel may also drive a pump used to return condensate water from the engine case to the boiler. The pocketed wheel carries the bodies, e.g., spheroids, from the lower end of the second passageway for passage into the expansion chamber and thence in the next succeeding cycle, along the first vertical passageway.

U.S. Pat. No. 29,149 to J. W. Durham describes an engine to obtain motive power which includes an endless chain of buckets arranged within a box of water with suitable pipes or other means of ingress or egress to and from the said box.

United States Patent Application Publication No. 2003/0127860 A1 to Baron describes a recirculating hydroelectric power generation system that is disclosed. The system includes a reservoir and at least one confinement column connected, and open to the reservoir at the base of the at least one confinement column. A source of pressurized air is provided and means for delivering the air to an air diffuser located near the base of the at least one confinement column. A guide chute is located at the top of the at least one confinement column in such a way that water exiting the top of the at least one confinement column is directed to a waterwheel or turbine, said waterwheel or turbine being operably connected to an electric generator unit.

Notwithstanding the prior art, the present invention is neither taught nor rendered obvious thereby.

### SUMMARY OF INVENTION

The present invention, in one broad embodiment, is a hydropower system with reciprocal floatation device for generating electric power. It includes a physical structure establishing a circuitous loop for flow of liquid that includes a liquid for circulating in the loop, an upper level, an upper midlevel and a lower midlevel and a lower level, the physical structure including components as follows: a) a liquid return conduit having a conduit outlet at the upper level; b) at least one reservoir located below the conduit outlet, the at least one reservoir being located between the upper level and the lower level, and having liquid dispensing means for dispensing the liquid from the at least one reservoir to a plurality of displacement columns reservoir; c) the plurality of displacement columns, each displacement column being located functionally below the reservoir liquid dispensing means; d) control means and valve means connected to the reservoir liquid dispensing means and the displacement column for sequentially adding and removing liquid to and from the displacement column for upward floatation of at least one weight and corresponding float for subsequent removal of liquid from the displacement column via gravitational force of the weight; e) a weight positioned within each of the displacement columns and arranged therein to reciprocally move up and down and to seal liquid under it at least during downward travel within the displacement column; f) a float connected to each the weight, the float having sufficient buoyancy to lift the weight; g) means for engaging the float to the weight for upward movement of the float and weight in rising liquid and disengagement of the float from the weight for removal of liquid from the displacement column via gravitational force of the weight; wherein, the weight and float have a reciprocal cycle having four positions, the four positions being: a first position with liquid rising, a second position with liquid at its maximum capacity, a third position with liquid releasing, and a fourth position with liquid at its lowest capacity, such that when the liquid is at its lowest capacity the disengaged weight and float engage, when the liquid rises, the engaged weight and float rise in the displacement column, when the liquid is at its maximum capacity the engaged weight and float disengage, and when the liquid is releasing the disengaged weight travels downward via gravity displacing the liquid from the displacement column through the appropriate valve means to the liquid return conduit with the conduit outlet at the upper level, completing a circuitous loop.

In some preferred embodiments of the present invention hydropower system with reciprocal floatation device for generating electric power, the system valve means includes at least a first valve and a second valve, wherein the first valve is located at the at least one reservoir liquid dispensing means and is functionally connected to the control means to control liquid flow from the reservoir to at least one of the plurality of displacement columns, and the second valve is a one way valve located between at least one displacement column and the liquid return conduit to permit liquid to flow from the at least one displacement column to the liquid return conduit and not vice versa.

In some preferred embodiments of the present invention hydropower system with reciprocal floatation device for generating electric power, the system includes four displacement columns, and four corresponding liquid dispensing means, four weights, four floats, four means for engaging and disengaging a float to a weight and four first valves and four second valves. In some of these preferred embodiments of the present invention hydropower system with reciprocal floatation device for generating electric power, each of the four weights and four floats are in different of the first position, and second position, the third position and the fourth position of its reciprocal cycle during operation thereof.

In some preferred embodiments of the present invention hydropower system with reciprocal floatation device for generating electric power, the at least one electric power producing hydro turbine is positioned between the reservoir and the plurality of displacement columns.

In some preferred embodiments of the present invention hydropower system with reciprocal floatation device for generating electric power, the system further includes a distribution tank for distributing liquid to the plurality of displacement columns, and wherein the return conduit is located at the upper level, the reservoir is located at the upper midlevel, the distribution tank is located at the lower midlevel and the plurality of displacement columns is located at the lower level.

The present invention, in a second broad embodiment, is a hydropower system with reciprocal floatation device for generating electric power that includes a physical structure with separate float displacement columns and weight displacement columns that are interconnected. The physical structure establishes a circuitous loop for flow of liquid that includes a liquid for circulating in the loop, an upper level, an upper midlevel and a lower midlevel and a lower level. The physical structure including components as follows: a) a liquid return conduit having a conduit outlet at the upper level; b) at least one reservoir located below the conduit outlet, the at least one reservoir being located between the upper level and the lower level, and having liquid dispensing means for dispensing the liquid from the at least one reservoir to a plurality of float displacement columns; c) the plurality of float displacement columns, each float displacement column being located functionally below the reservoir liquid dispensing means; d) a plurality of weight displacement columns located below the plurality of float displacement columns; e) at least one electric power producing hydro turbine located within the loop and upstream from the plurality of displacement columns; f) control means and valve means connected to the reservoir liquid dispensing means and the float displacement columns for sequentially adding and removing liquid to and from the float displacement columns and the weight displacement columns for upward floatation of at least one weight and corresponding float for subsequent removal of liquid from the displacement column via gravitational force of the weight; g) a weight positioned within each of the weight displacement columns and arranged therein to reciprocally move up and down and to seal liquid under it at least during downward travel within the weight displacement column; h) a float connected to each the weight, the float being within the float displacement columns and having sufficient buoyancy to lift the weight; i) means for sequentially filling the float displacement columns to raise the float and the weight, holding one of the float and the weight at a float displacement column liquid filled position, moving the liquid from the float displacement columns to the weight displacement columns, releasing the float and connected weight, so as to permit the weight to remove liquid from the weight displacement columns to the liquid return conduit via gravitational force of the weight; wherein the weight and float have a reciprocal cycle having four positions, the four positions being: a first position with liquid rising in the float displacement columns and the float lifting the weight, a second position with liquid at its maximum capacity in the float displacement columns wherein one of the float and the weight is held to hold the weight in an elevated position in the weight displacement columns, a third position with liquid releasing from the float displacement columns to the weight displacement columns to fill the weight displacement columns with liquid up to the weight, and fourth position with the float or weight released and the weight removing liquid from the weight displacement columns caused by the weight traveling downward via gravity and displacing the liquid from the weight displacement columns through the appropriate valve means to the liquid return conduit with the conduit outlet at the upper level, completing a circuitous loop and driving the at least one electric producing power hydro turbine.

In some preferred embodiments of the present invention hydropower system with reciprocal floatation device for generating electric power with separate displacement columns for the floats and weights, the system valve means includes at least a first valve and a second valve, wherein the first valve is located at the at least one reservoir liquid dispensing means and is functionally connected to the control means to control liquid flow from the reservoir to at least one of the plurality of float displacement columns, and the second valve is a one way valve located between at least one weight displacement column and the liquid return conduit to permit liquid to flow from the at least one weight displacement column to the liquid return conduit and not vice versa.

In some preferred embodiments of the present invention hydropower system with reciprocal floatation device for generating electric power with separate displacement columns for the floats and weights, the system includes four float displacement columns and weight displacement columns, and four corresponding liquid dispensing means, four weights, four floats, and four first valves and four second valves. In some of these preferred embodiments of the present invention hydropower system with reciprocal floatation device for generating electric power with separate displacement columns for the floats and weights, each of the four weights and four floats are in different of the first position, and second position, the third position and the fourth position of its reciprocal cycle during operation thereof.

In some preferred embodiments of the present invention hydropower system with reciprocal floatation device for generating electric power with separate displacement columns for the floats and weights, the at least one electric power producing hydro turbine is positioned between the reservoir and the plurality of displacement columns.

In some preferred embodiments of the present invention hydropower system with reciprocal floatation device for generating electric power with separate displacement columns for the floats and weights, the system further includes a distribution tank for distributing liquid to the plurality of float displacement columns, and wherein the return conduit is located at the upper level, the reservoir is located at the upper midlevel, the distribution tank is located at the lower midlevel and the plurality of float displacement columns is located at the lower level with the weight displacement columns located below the float displacement columns.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a block diagram of one preferred embodiment of the present invention system with floats and weights paired in single displacement columns;

FIG. 2 is a detailed block diagram of one preferred embodiment of the present invention shown in FIG. 1;

FIG. 3 is a block diagram of another preferred embodiment of the present invention system such as shown in FIG. 1, but without the distribution tank;

FIG. 4 is a cross-sectional view of the present invention system of the type shown in FIG. 2 in a first position of its reciprocal cycle;

FIG. 5 is a cross-sectional view of the present invention system of the type shown in FIG. 2 in a second position of its reciprocal cycle;

FIG. 6 is a cross-sectional view of the present invention system of the type shown in FIG. 2 in a third position of its reciprocal cycle;

FIG. 7 is a cross-sectional view of the present invention system of the type shown in FIG. 2 in a fourth position of its reciprocal cycle;

FIG. 8 is a manifold diagram of a present invention system with four reservoir outlets;

FIG. 9 is a block diagram of another preferred embodiment of the present invention wherein the weights and floats are located in separate, connected displacement columns;

FIG. 10 is a detailed block diagram of one preferred embodiment of the present invention system shown in FIG. 9;

FIG. 11 is an a block diagram of another preferred embodiment of the present invention system shown in FIG. 9;

FIG. 12 is a cross-sectional view of the present invention system shown in FIG. 10 in one position of its reciprocal cycle;

FIG. 13 is a cross-sectional view of the present invention system shown in FIG. 10 in a second position of its reciprocal cycle;

FIG. 14 is a cross-sectional view of the present invention system shown in FIG. 10 in a third position of its reciprocal cycle;

FIG. 15 is a cross-sectional view of the present invention system shown in FIG. 10 in a fourth position of its reciprocal cycle;

FIG. 16 is a manifold diagram of the present invention system shown in FIG. 10 with four reservoir outlets.

### DETAILED DESCRIPTION OF THE EMBODIMENTS

The present system generates electric power using a system with a continuous or semi-continuous loop of a circulating liquid. The loop is one or more complete loops and a “semi-continuous” loop is one wherein the flowing liquid is not continuous. The loop includes the circulating liquid, e.g. water, one or more reservoirs, one or more weights, and one or more floatation devices. The liquid flows from a reservoir located above a distribution tank through one or more turbines that can be used to generate power. (In some embodiments, the reservoir simultaneously serves as the distribution tank, in which case a separate distribution tank is not utilized.) The liquid exits from the distribution tank into a plurality of displacement columns which are lower than the distribution tank. Each displacement column includes at least one or more weights and floatation devices. The liquid raises the weight and flotation device to a predetermined height. When the floatation device reaches this height, the weight disengages from the float. The disengaged weight drops via gravity and forces the liquid, e.g. water, through each displacement column. The liquid flows out of the displacement column through a one way valve to prevent backflow and then up a conduit to return to the reservoir.

Stated in another manner, a circulating liquid flows through a continuous or semi-continuous loop, starting first in a reservoir. The liquid in the reservoir is released from the reservoir, turning at least one turbine, and flows into a distribution tank. The purpose of the distribution tank is to act as an outlet with at least one valve means to empty the liquid into a plurality of displacement columns. Each displacement column has one or more weights and floats, and at least one displacement column has a corresponding engaged pair of a float and weight which rests at the bottom of its column. The density of the weight multiplied by its volume in addition to the density of the float multiplied its volume must be less than the density of the liquid multiplied by the combined volume of the weight and float. Correspondingly, the density of the weight multiplied by its volume must be greater than the density of the liquid multiplied by the volume of the weight. As the liquid enters the displacement column, the float and the weight rise to a predetermined height, at which point the float disengages from the weight. The weight drops via gravity and forces the liquid out of the column through a one way valve to prevent any backflow into the column. The float then engages with the weights at the bottom of the empty displacement column. Once the liquid passes through the one way valve, it passes through a return conduit and returns through an outlet to the aforementioned reservoir.

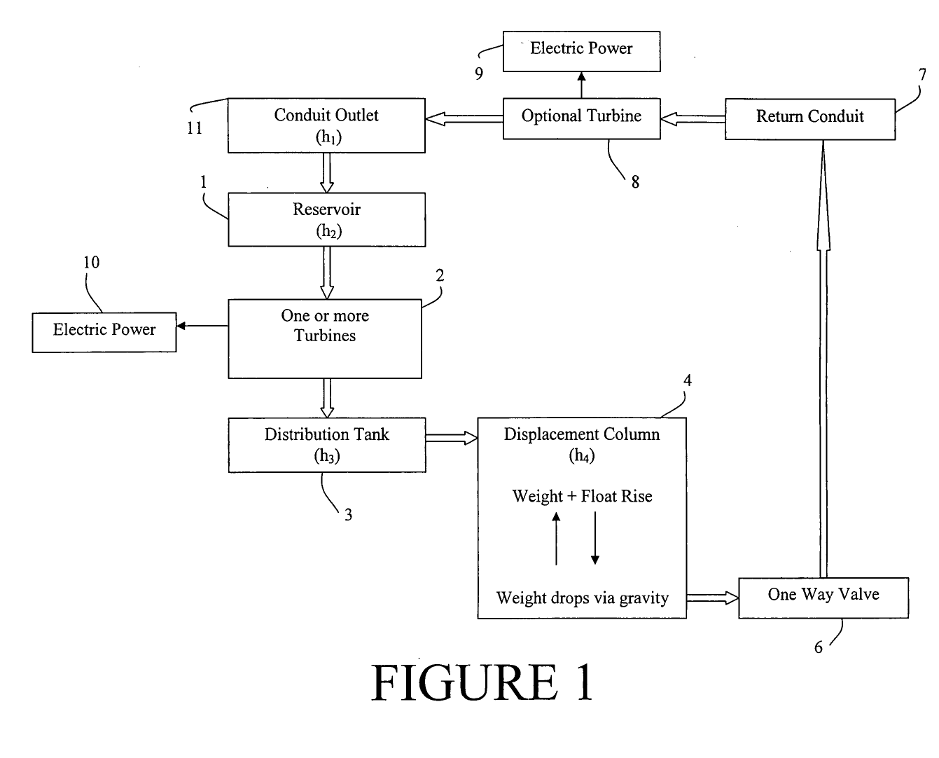

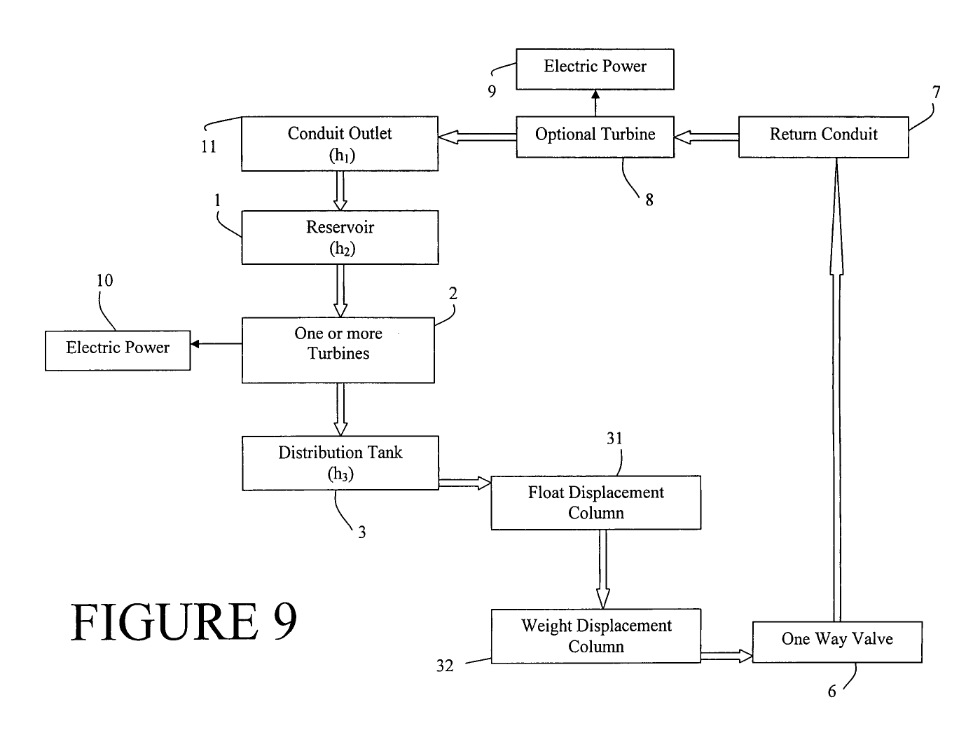

Generally, there are two possible arrangements for floatation systems within the scope of the present invention. One arrangement involves physical or distal separation between the float and the weight, as just described, while a second arrangement involves a fixed relationship between the float and the weight with no distance change or separation between the two. The first arrangement is illustrated by FIGS. 1 through 8 and the second arrangement is illustrated by FIGS. 9 through 16. A detailed discussion of each follows.

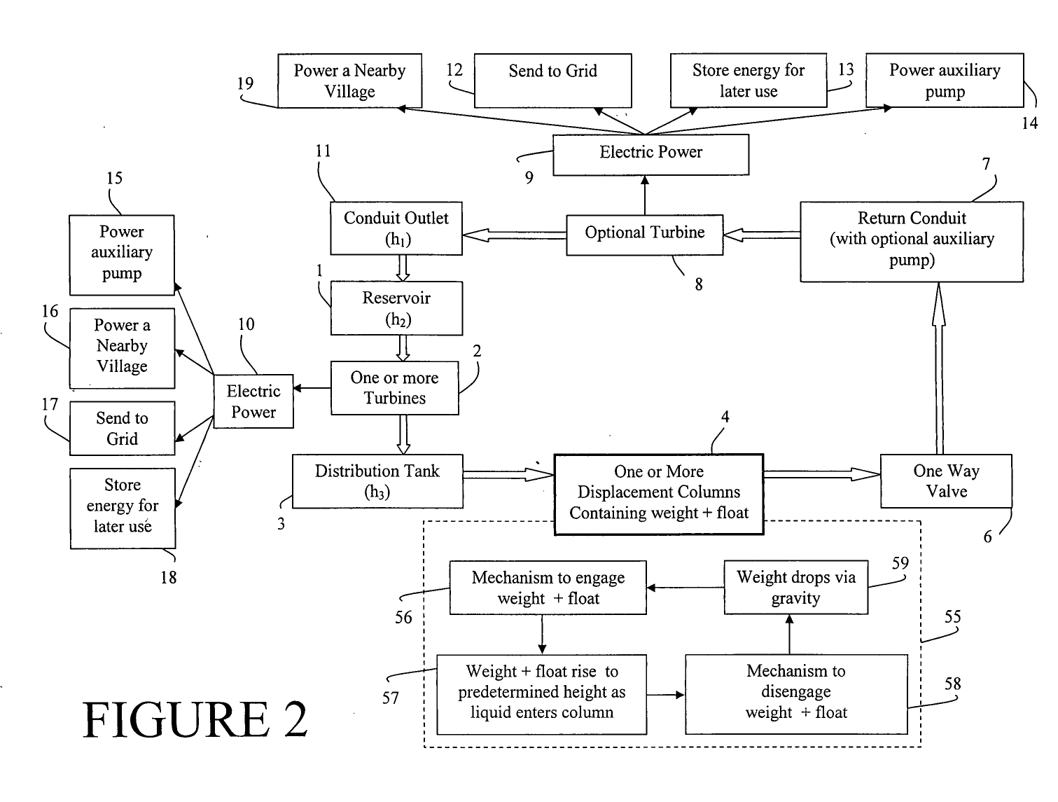

In one preferred embodiment of the hydropower system, a continuous or semi-continuous circuitous loop system shown in both FIG. 1 and FIG. 2 includes a reservoir 1, with a loop conduit outlet 11 located above it at an upper height (predetermined height h₁). The reservoir is located at an upper midlevel height (predetermined height h₂), and one or more turbines 2 are located downstream from the reservoir 1, as shown. One or more distribution tanks 3, at a lower midlevel position (predetermined height h₃, wherein h₁ is greater than h₂, and h₂ is greater than h₃). Thus, the reservoir 1 is located above the one or more turbines 2 and below a conduit outlet 11. The reservoir 1 includes a liquid for circulation, represented by thick arrows in FIG. 1 and FIG. 2 (and all other FIGURES throughout this application). The reservoir 1 has at least one inlet and at least one outlet for the circulating liquid to enter and exit. The circulating liquid exits the reservoir 1 at the one or more outlets and turns one or more turbines 2 to create electric power 10. While FIG. 1 and FIG. 2 show the one or more turbines 2 between the reservoir 1 and distribution tank 3, the one or more turbines 2 may be located above the reservoir 1, at the reservoir 1, between reservoir 1 and distribution tank 3, at the distribution tank 3, between the distribution tank 3 and a plurality of displacement columns 4, or any combination thereof without exceeding the scope of the present invention. As indicated in FIG. 2, the electric power 10 can be used for, but is not limited to, stored energy 18, electric power sent to a grid 17, energy to power a nearby village 16 or any other consuming entity, or to power an optional auxiliary pump 15 that would help the flow of circulating liquid up a return conduit 7, as well as any combination of the foregoing, or any other use.

In one preferred embodiment of the invention, the reservoir 1 has a constant flow of circulating liquid entering and exiting through the inlet and outlet (not shown). The constant flow exiting the reservoir 1 would turn the one or more turbines 2 continuously, allowing a continual generation of electric power 10.

The circulating liquid turns the one or more turbines 2 and enters the distribution tank 3 through one or more inlets. The distribution tank 3 is located between the reservoir 1 and a plurality of displacement columns 4. The distribution tank 3 includes one or more outlets that allow the circulating water to enter the plurality of displacement columns 4. The distribution tank 3 retains the circulating liquid before the liquid exits into the plurality of displacement columns 4 and acts both as a water level control point and a timing sequence control point for manifolding the liquid to the displacement columns 4. In some embodiments of the system, the number of outlets on the distribution tank 3 may be directly related to the number of inlets on the each displacement column 4.

Each displacement column 4 includes one or more weights and one or more floats. The one or more weights and floats combined are more buoyant than the circulating liquid and rise in the displacement column 4 as the liquid enters through the inlet. Referring to FIG. 2, the one or more floats and weights rise to a predetermined height 57 at which point the weight disengages from the float 58, but may or may not still be attached to the float. The weight is less buoyant than the circulating liquid and drops via gravity 59, forcing the water through a one way valve 6 located in some given position between the displacement column outlet and a return conduit 7. The one way valve 6 is to prevent backflow into the displacement column 4. The weight and float may then engage by an engagement mechanism 56, and reciprocate the rise and drop motions represented by frame 55 in the displacement column 4.

Referring to both FIGS. 1 and 2, the circulating liquid enters the return conduit 7 through the one way valve 6 and, in some preferred embodiments, may pass through one or more optional turbines 8 to generate electric power 9. The return conduit 7 completes the circuitous loop, allowing the liquid to travel through the conduit outlet 11 and into the aforementioned reservoir 1 through the conduit outlet 11. It is the rise of the weight by the float and subsequent release of the weight from the float that, in these embodiments, pushes the liquid through the loop to generate power. It is relevant to have a mechanism for making sure that the liquid filling the displacement column lifts the float and attached weight by surrounding both the float and the weight with liquid; yet maintaining the liquid that is below the rising weight to stay below it when the weight has been released and is falling. This may be accomplished by any number of arrangements, such as an annulus or other opening between the weight and the displacement column that is open when the liquid is filling the column and closed when the weight is dropping and pushing the liquid out of the column. Time-based or event-based or movement-based opened/closed one way valves are well known and are well within the abilities of the artisan, and are thus not detailed herein. To put it simply, a one way valve would be located at the weight that would open during the displacement column filling step (float and weight rising) and this one way valve would be closed during the displacement column emptying step (weight falling).

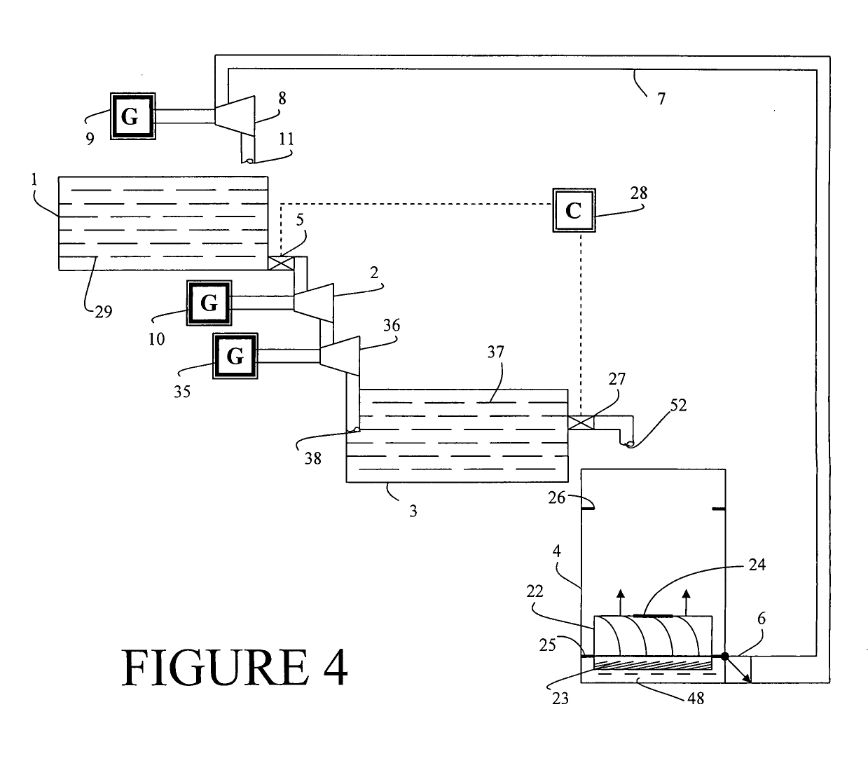

Each of the plurality of displacement columns 4 includes a set of one or more weights and one or more floats having a reciprocal cycle. The system shown in FIGS. 4 through 7 is the same system shown in FIG. 2. FIGS. 4 through 7, respectively, display the system in its four cyclical positions: with liquid rising 48, with liquid at its maximum 49, with liquid releasing 50, and with liquid at its minimum 51.

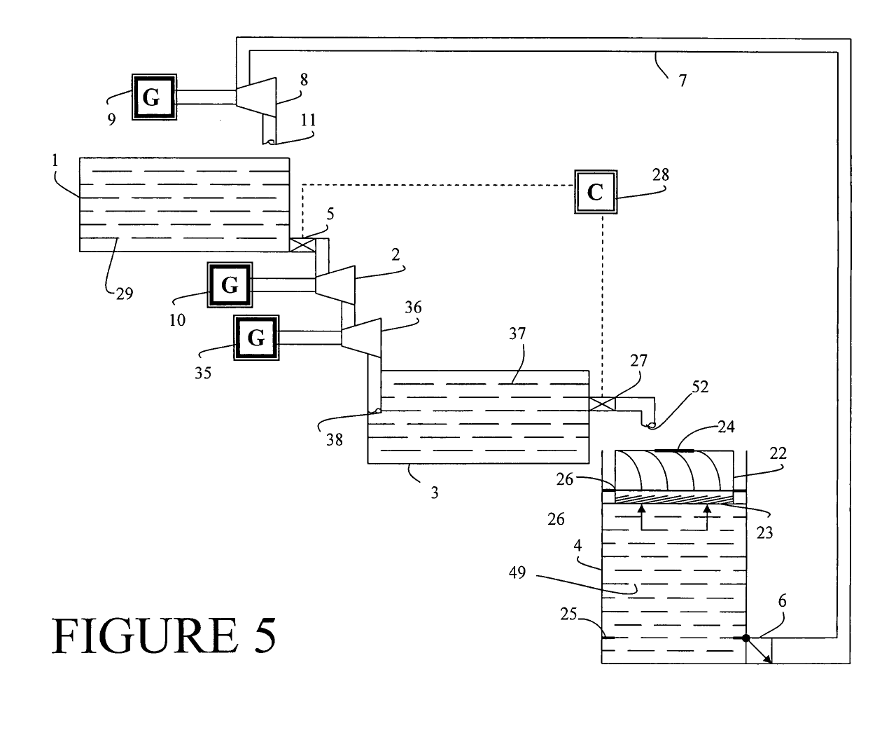

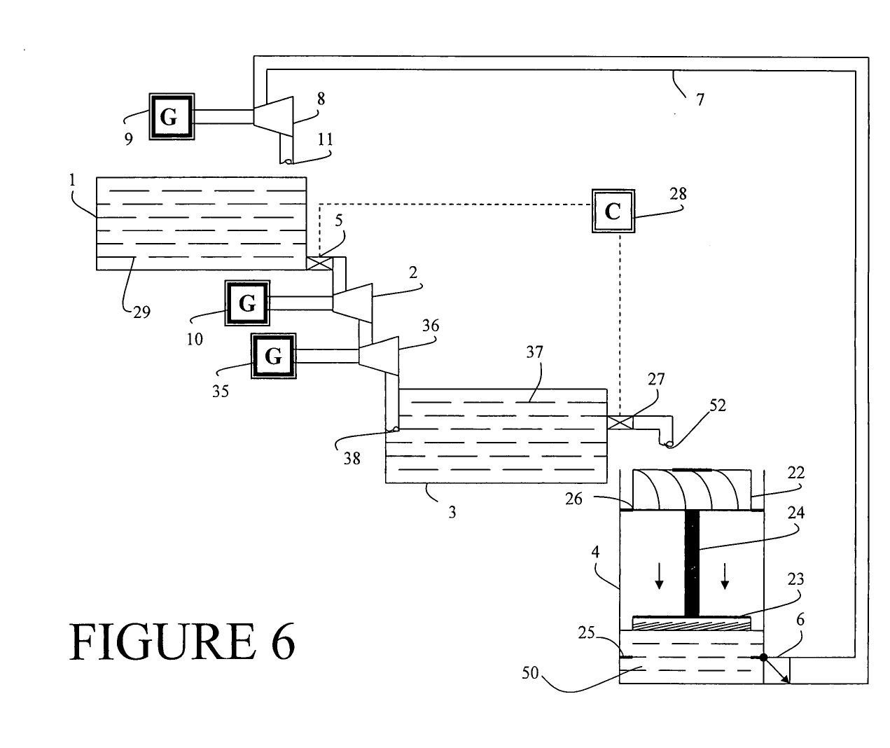

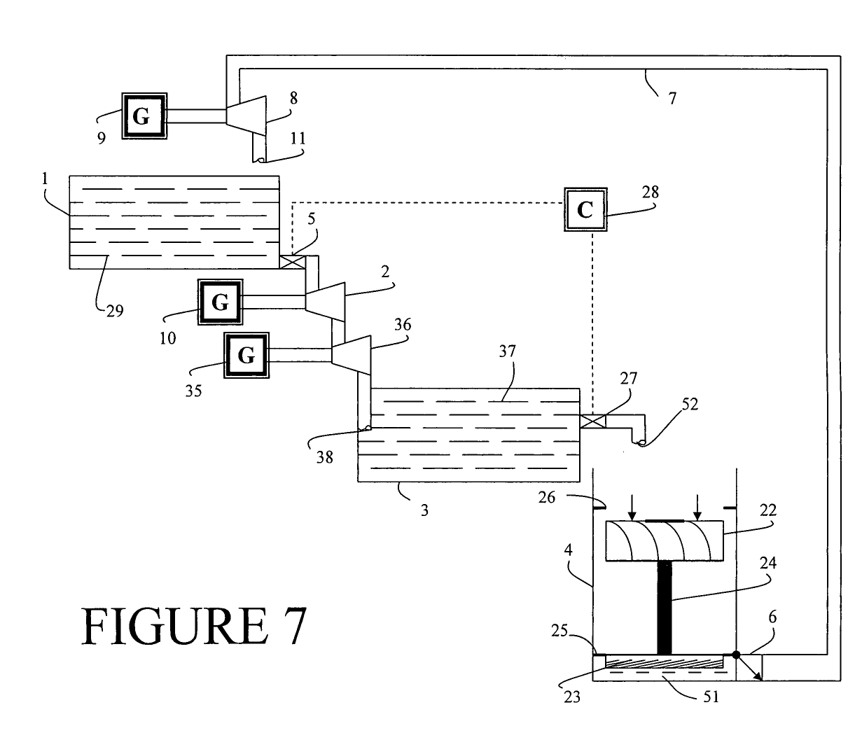

In some preferred embodiments, referring again to the FIGS. 4 through 7, the displacement column 4 may have two predetermined heights at which point the float 22 and weight 23 will engage and disengage by an engage/disengage mechanism 24. This mechanism 24 may be swing latches, pin locks or any other lock/unlock device, and may be operated by hydraulics, pneumatics, mechanics, magnetics, electronics or combinations and may effect engagement and disengagement by opening and closing via computer controls, sensors, timers or otherwise. The predetermined height 25 at which the float 22 engages with the weight 23 may be lower than the predetermined height 26 at which the float 22 disengages from the weight 23 in the displacement column 4. As shown in FIG. 4, the system is in its first position where liquid is rising 48. In the first position, the weight 23 and float 22 are engaged and rest at a lower predetermined height 26 in at least one displacement column 4. The engaged float and weight rise to the predetermined height 22 as the circulating liquid enters the displacement column 4 through the one or more inlets 52. When the engaged float 22 and weight 23 reach the upper predetermined height 26, the circulating liquid is at its maximum 49 as shown in FIG. 5. Some mechanism 24 then disengages the float 22 from the weight 23 and the weight 23 drops via gravity. FIG. 6 shows the third position as the circulating liquid releases 50 from the displacement column 4. When the weight 23 reaches the lower predetermined height 25, the circulating liquid is at its minimum 51, as shown in FIG. 7, and the weight 23 and float 22 may engage per some mechanism 24.

When the weight 23 and float 22 reach the upper predetermined height 26, the weight 23 disengages from the float 22, but may or may not still be attached to the float 22 per the engaging and disengaging mechanism 24. In one preferred embodiment of the present invention, the float 22 is attached to the weight 23 using a pole and key locking mechanism. The pole connects the weight 23 to the float 22 and may connect the two at all times throughout the engaging and disengaging process. The key is used to engage and disengage the two at the predetermined heights. The exact details of the mechanism 24 may be any described above or otherwise, as long as engagement and disengagement are accomplished at the correct water levels and times to effect the sequence of steps described. In another preferred embodiment of the present invention, the float 22 may inflate and deflate at the upper 26 and lower 25 predetermined heights in the displacement column 4 to rise and sink with the weight 23. As the float 22 inflates, the weight 23 and float 22 rise, and as the float 22 deflates, the weight 23 drops forcing the liquid through the outlet of the displacement column 4. The exact method of the mechanism is not limited to, but may include, any of these embodiments, as the exact method of the weight 23 and float 22 engagement and disengagement mechanism 24 for the system is a matter of design choice.

In each displacement column 4, the disengaged weight 23 must seal the circulating liquid 50 below it on downward travel. In one preferred embodiment of the invention, the weight 23 has one way flaps (one way valves choice) that allow water 29 to flow from above the weight 23 to below the weight 23 and not vice versa. The purpose of the one way flaps is to keep liquid below the weight 23 at all times when the weight 23 drops via gravity so that the releasing liquid 50 can be forced out of the displacement column 4 rather than circulate in the column 4.

When the weight 23 is disengaged and dropped via gravity, the circulating liquid 50 is forced through the outlet of the displacement column 4 and through a one way valve 6 at the entrance to a return conduit 7. The one way valve 6 prevents any backflow of the liquid into the displacement column 4 and therefore prevents the liquid from equilibrating between the return conduit 7 and the displacement column 4. As the liquid 50 is forced out of the displacement column 4, the liquid is forced through the return conduit 7. In some preferred embodiments, an auxiliary pump may or may not be used to help the flow of the liquid through the return conduit 7. The return conduit 7 is a method of transporting the circulating liquid from the one plurality of displacement columns 4 back to the original reservoir 1, making the system a continuous loop. In some preferred embodiments, an optional turbine 8 may be located in the return conduit 7. The optional turbine 8, like the turbines 2 and 36 between the reservoir 1 and the distribution tank 3, may generate electric power 9 which can be used for, but is not limited to, stored energy 13, electric power sent to a grid 12, energy to power a nearby village 19, or to power the optional auxiliary pump 14. The optional turbine 8 may be located anywhere at or between the one way valve 6 and the conduit outlet 11. The circulating liquid may pass through the optional turbine 8 and exit the return conduit 7 through the conduit outlet 11 located above the reservoir 1. The liquid may then repeat its course and circulate continuously through the system.

If more than one displacement column 4 is used, the starting heights of the liquid levels and engaged floats 22 and weights 23 may vary. The purpose of the alternating heights or steps in different displacement columns is to keep a steady flow of circulating liquid through the system.

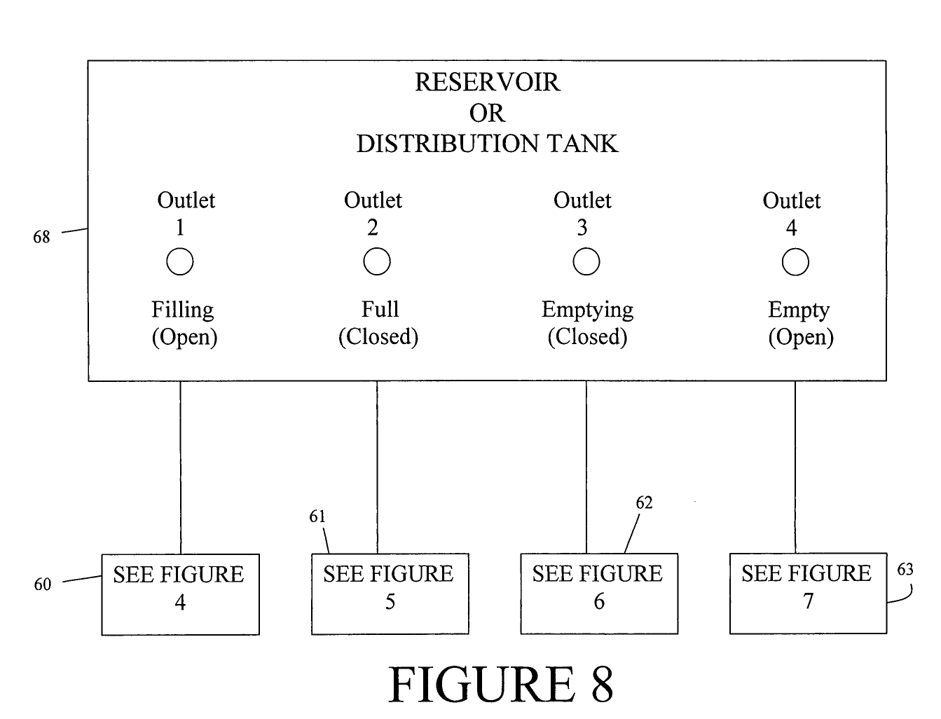

FIG. 8 is a manifold 68 of one preferred embodiment of the present invention with four reservoir outlets, two open and two closed, and four distribution columns: one filling, one full, one emptying, and one empty. The four different displacement columns 4 are in four different stages of the reciprocal motion. The first outlet is open, allowing liquid to enter and rise in one displacement column at the position shown in FIG. 4, frame 60. Simultaneously, the second outlet is closed, because the circulating liquid is at its maximum capacity in a second column shown in the position in FIG. 5, frame 61. A third outlet is closed, preventing circulating liquid to enter into a column in the position shown in FIG. 6, frame 62, where liquid is releasing from the column. The fourth outlet is open, and circulating liquid enters a column in the position shown in FIG. 7, frame 63, where liquid is at its minimum. For the system to maintain a steady flow, the alternate starting heights may be dependant on the number of displacement columns 4. In a preferred embodiment, the net flow rates of the liquid entering and filling the column may be equal to the net flow rates emptying and exiting the displacement column 4. This staggering prevents every displacement column 4 from filling and emptying at the same time, allowing the liquid to flow continuously through the return conduit 7.

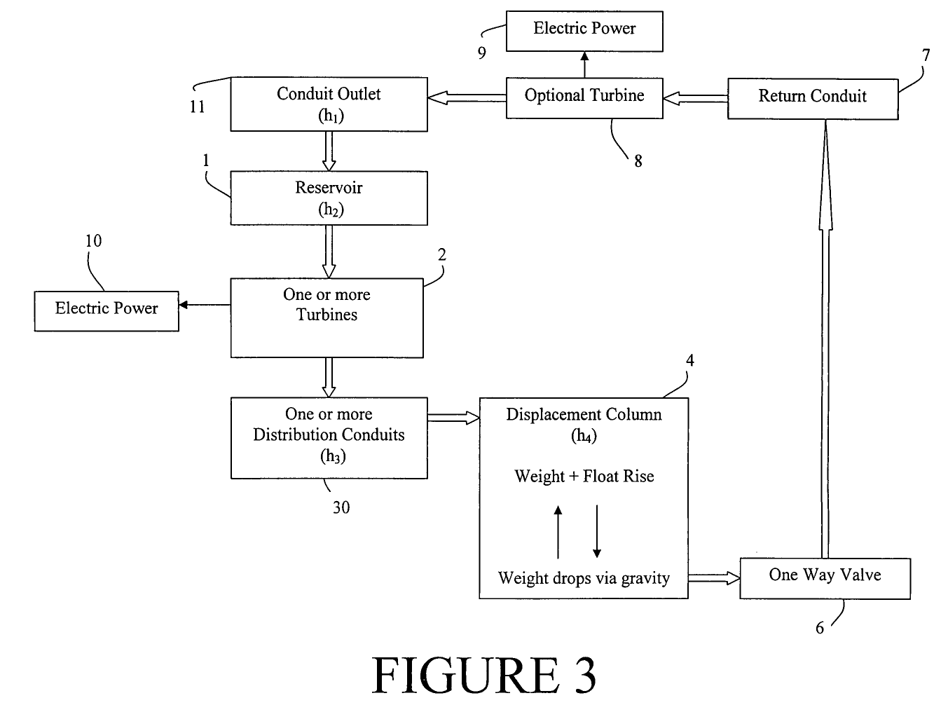

In one preferred embodiment of the present invention shown in FIG. 3, a distribution tank is not required. Like the present invention systems in FIG. 1 and FIG. 2, the system includes a circulating liquid, one or more reservoirs, one or more weights, and one or more floatation devices. Rather than exiting the reservoir 1 to a distribution tank, the reservoir 1 has at least one or more outlets that transport the circulating liquid in one or more distribution conduits 30 to one or more displacement columns 4. The one or more distribution conduits 30 include at least one or more turbines 2 that the circulating liquid turns to generate electric power 10. When the liquid enters the one or more displacement columns 4, the system is similar to the embodiments in FIG. 1 and FIG. 2, and use a float 22 and weight 23 system to force water out of the columns, through a one-way valve 6 into a return conduit 7 with an optional turbine 8 and back into the reservoir 1.

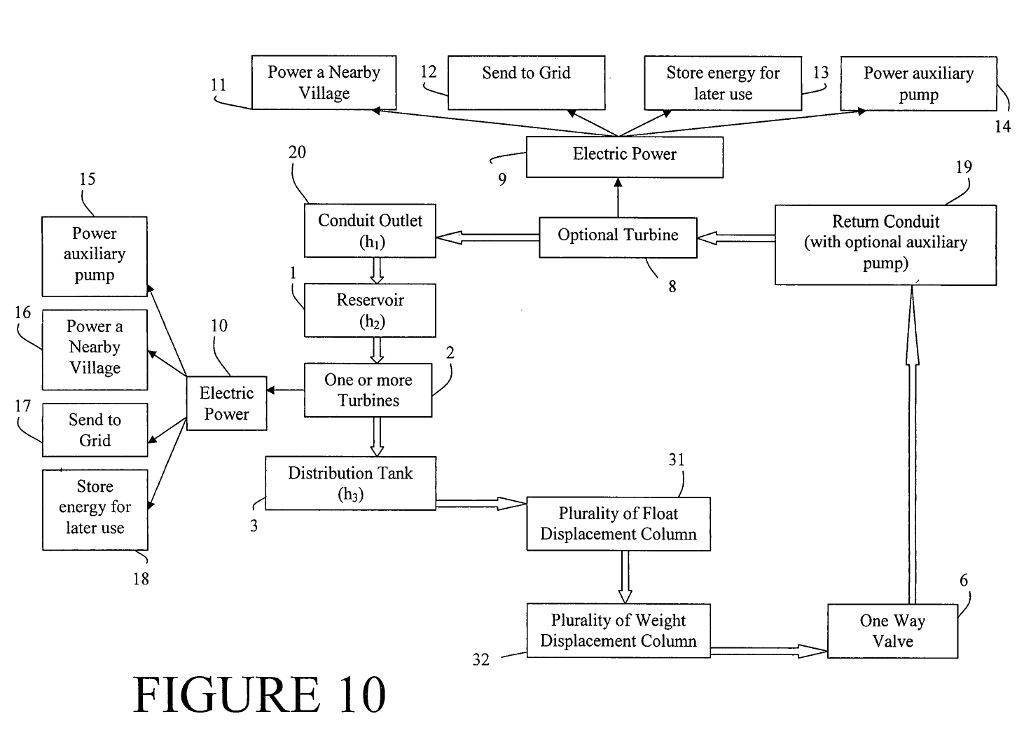

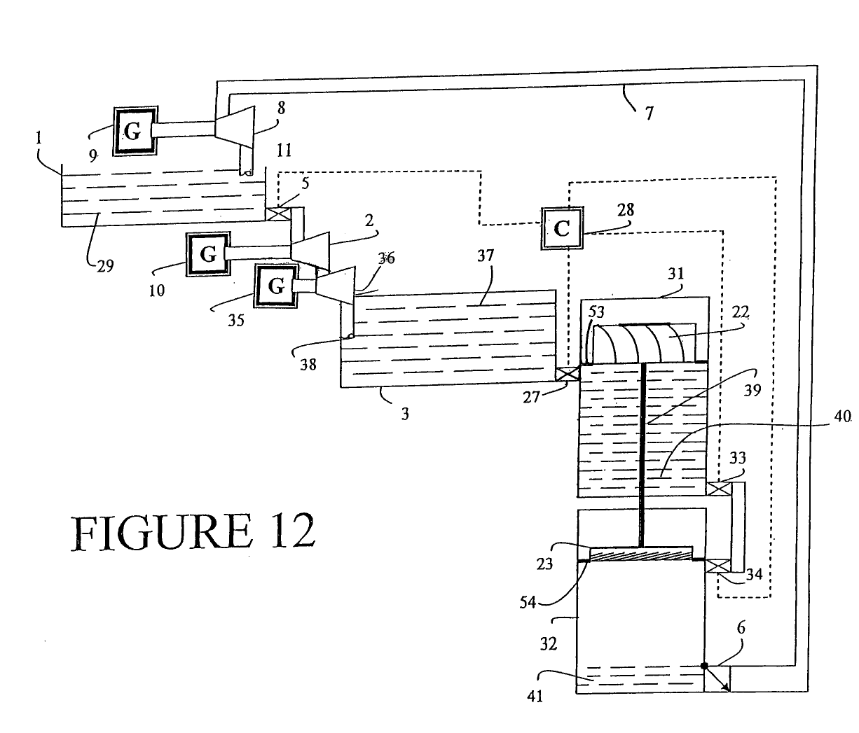

In another broad type of preferred embodiment of the present invention hydropower system, a continuous or semi-continuous circuitous loop system shown in both FIG. 9 and FIG. 10 includes of a reservoir 1, with a loop conduit outlet 11 located above it at an upper height (predetermined height h₁). The reservoir is located at an upper midlevel height (predetermined height h₂), and one or more turbines 2 are located downstream from the reservoir 1, as shown. One or more distribution tanks 3, at a lower midlevel position (predetermined heightₕ₃ wherein h₁ is greater than h₂, and h₂ is greater than h₃.) Thus, the reservoir 1 is located above the one or more turbines 2 and below a conduit outlet 11. Liquid circulation is represented by thick arrows, as mentioned. FIGS. 12 through 15 show two-dimensional cross sections of the system displayed in FIG. 10 in four different positions or the reciprocal cycle. The reservoir 1 is located above one or more turbines 2 and below a conduit outlet 11. The reservoir 1 has at least one inlet and at least one outlet for the circulating liquid to enter and exit. The circulating liquid exits the reservoir 1 at the one or more outlets and turns one or more turbines 2 to create electric power 10. While FIG. 9 and FIG. 10 show the one or more turbines 2 between the reservoir 1, and distribution tank 3, the one or more turbines 2 may be located above the reservoir 1, at the reservoir 1, between reservoir 1 and distribution tank 3, at the distribution tank 3, between the distribution tank 3 and a plurality of displacement columns 4, or any combination thereof without exceeding the scope of the present invention. As indicated in FIG. 10, the electric power 10 can be used for, but is not limited to, stored energy 18, electric power sent to a grid 17, energy to power a nearby village 16 or any other consuming entity or to power an optional auxiliary pump 15 that would help the flow of circulating liquid up a return conduit 7, as well as any combination of the foregoing, or any other use.

The circulating liquid 29 from the reservoir 1 passes through a valve 5, turns at least one turbine 2, and enters the distribution tank 3 through one or more inlets 38. The distribution tank 3 is located between the reservoir 1 and a plurality of float displacement columns 31. The distribution tank 3 includes one or more outlets with a controlled valve 27 that allows the circulating liquid to enter the plurality of float displacement columns 31 located at some height above a plurality of weight displacement column 32. The distribution tank 3 retains the circulating liquid 37 before the liquid exits into the plurality of float displacement columns 31.

Each float displacement column 31 includes one or more floats. The plurality of float displacement columns 31 are located functionally above at least one of the plurality of weight displacement columns 32. The plurality of float displacement columns 31 with a plurality of floats 22 may run in sequence or in parallel and may have simultaneous lift with sequential drainage.

Referring to the FIGS. 12, 13, 14 AND 15, A mechanism 39 connects at least one weight 23 and one float 22 from one float and weight column. The liquid enters the float displacement columns 31. When the liquid is at a maximum in the float displacement column 31, the liquid passes through at least one valve and enters the weight distribution column 32. When the liquid in the weight distribution column 32 is at its maximum, the weight 23 drops, forcing the liquid to exit the weight distribution column 32 through a one way valve 6 and into a return conduit 7. The liquid may then pass through an optional turbine 8 to generate electric power 9 before exiting through a conduit outlet 11 into the reservoir 1.

FIGS. 12 through 15, respectively display the system in its four possible positions: with liquid at its maximum 40 in the float displacement column 31 and liquid at its minimum 41 in the weight displacement column 32, with liquid releasing 42 in the float displacement column 31 and liquid rising to its maximum 43 in the weight displacement column 32, with liquid at its minimum 44 in the float displacement column 31 and liquid releasing from its maximum 45 in the weight displacement column 32, and with liquid rising 46 in the float displacement column 31 and the liquid at its minimum 47 in the weight displacement column 32. There are two valves shown in the figures in the pipe or conduit connecting the float displacement column 31 to the weight displacement column 32. Although valve 33 and valve 34 are displayed, the system only involves at least one valve which may be positioned either at the outlet of the float displacement column 31, the inlet to the weight displacement column 32, anywhere in between the two, or any combination thereof.

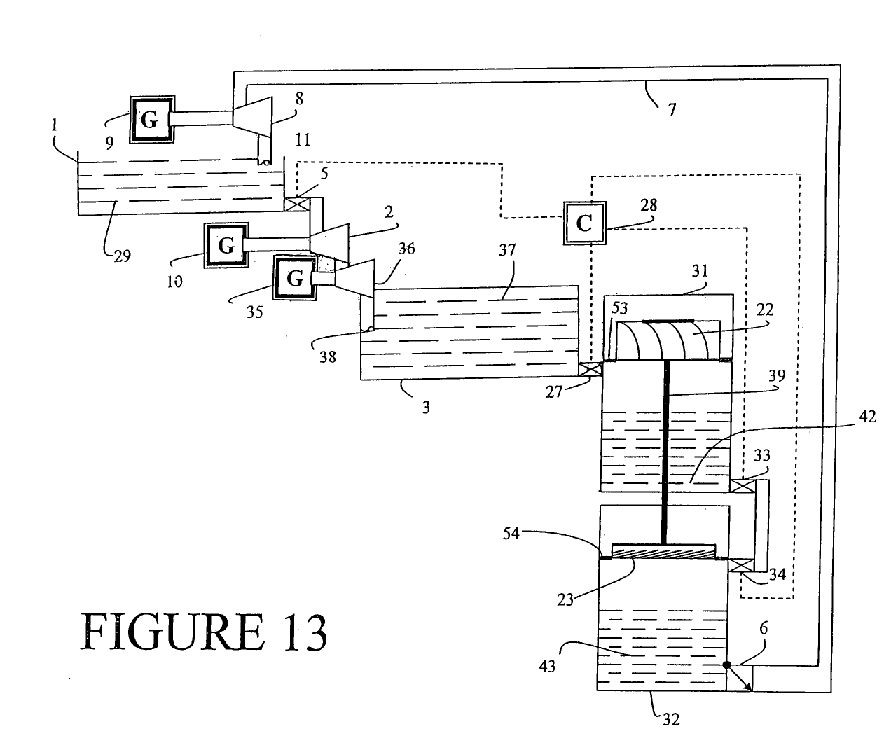

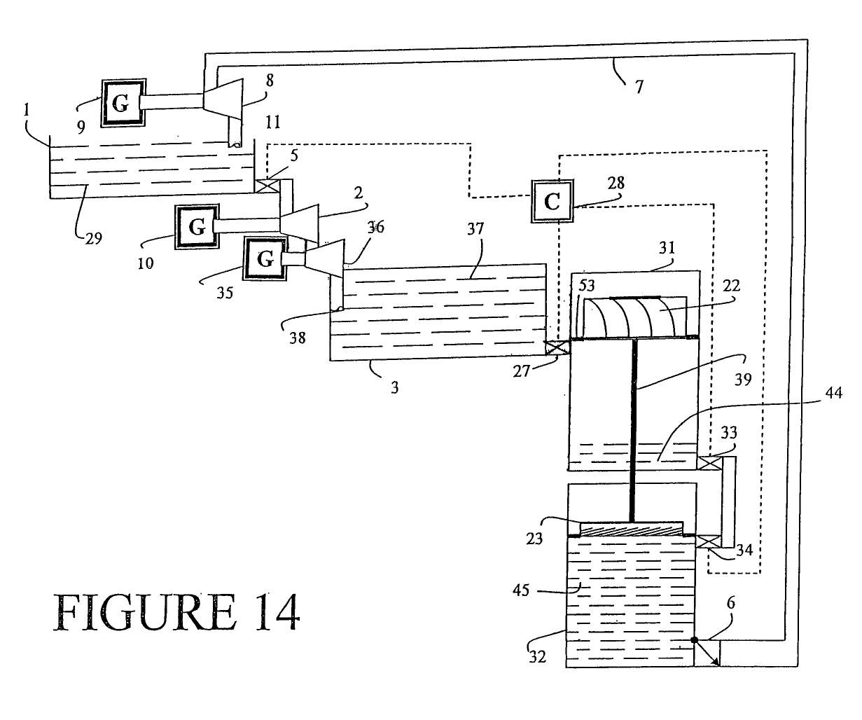

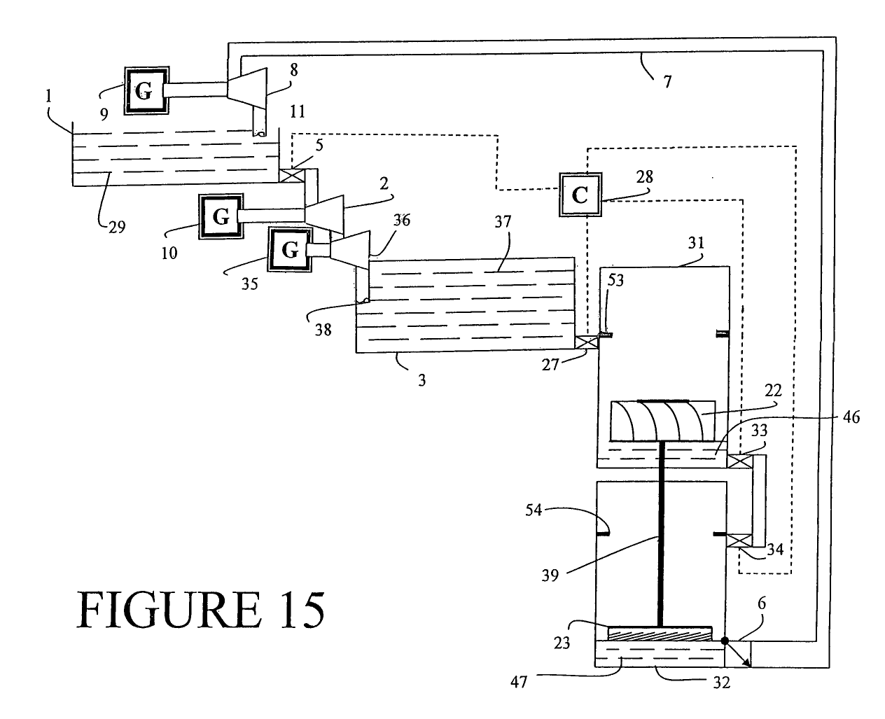

The mechanism 39 may keep the weight 23 and float 22 at a predetermined distance from one another and may maintain that constant distance throughout each reciprocal motion. The one or more floats 22 attached the to the one or more weights 23 have a combined buoyancy greater than the circulating liquid, allowing each to rise in their respected columns as the liquid passes through the valve 27 and enters the float displacement column 31. FIG. 12 shows the position with liquid at its maximum 40 in the float displacement column 31 and liquid at its minimum 41 in the weight displacement column 32. At this position, the float 22 is at its maximum predetermined height 53 and is connected by some mechanism 39 to the weight 23 at its maximum predetermined height 54. When the weight and float reach this height, both valve 33 and valve 34 open, allowing the liquid to release 42 from the float displacement column 31 and rise to its maximum 43 in the weight displacement column 32 as shown in FIG. 13. FIG. 14 shows the liquid at its minimum 44 in the float displacement column 31 and the liquid releasing from its maximum 45 in the weight displacement column 32. When the liquid reaches its maximum 43 in the weight displacement column 32, the weight 23 attached to the float 22 both drop. The weight is less buoyant than the circulating liquid and seals the liquid by some method below it. The float 22 drops through the empty float displacement column 31 as the weight 23 drops forcing the liquid out of the weight displacement column 32. FIG. 15 shows the fourth position with liquid rising 46 in the float displacement column 31 and the liquid at its minimum 47 in the weight displacement column 32. As liquid continues to enter the float displacement column 31, the float 22 rises to its predetermined height 53 and continually reciprocates the rise and fall motions.

If more than one float displacement column 31 and weight displacement column 32 are present in the system, the starting heights of the liquid levels may be different in each column. The purpose of the alternating heights is to keep a steady flow of circulating liquid through the system. FIG. 16 is a manifold 21 of one preferred embodiment of the present invention with four reservoir outlets, two open and two closed, four float displacement columns 31 and four weight displacement columns 32: one weight displacement column empty, one weight displacement column filling, one weight displacement column full, and one weight displacement column emptying. The four different weight and float distribution columns are in four different stages of the reciprocal motion. The first outlet is open, entering one float displacement column at the position shown in FIG. 12, frame 64 with the circulating liquid rising in the float displacement column. Simultaneously, the second outlet is closed, as another float displacement column in the position shown in FIG. 13, frame 65 is releasing its liquid. A third outlet is closed, preventing circulating liquid to pour into another float displacement column in the position shown in FIG. 14, frame 66, where liquid is at its minimum in the column. The fourth outlet is open, and circulating liquid enters another float displacement column in the position shown in FIG. 15, frame 67, where liquid is rising in the column. For the system to maintain a steady flow, the alternate starting heights may be dependant on the number of float 31 and weight displacement columns 32. In a preferred embodiment, the net flow rates of the liquid entering and filling the float displacement column 31may be equal to the net flow rates emptying and exiting the weight displacement column 32. This staggering prevents each float displacement column and weight displacement column from filling and emptying at the same time, allowing the liquid to continuously enter and exit the return conduit 7.

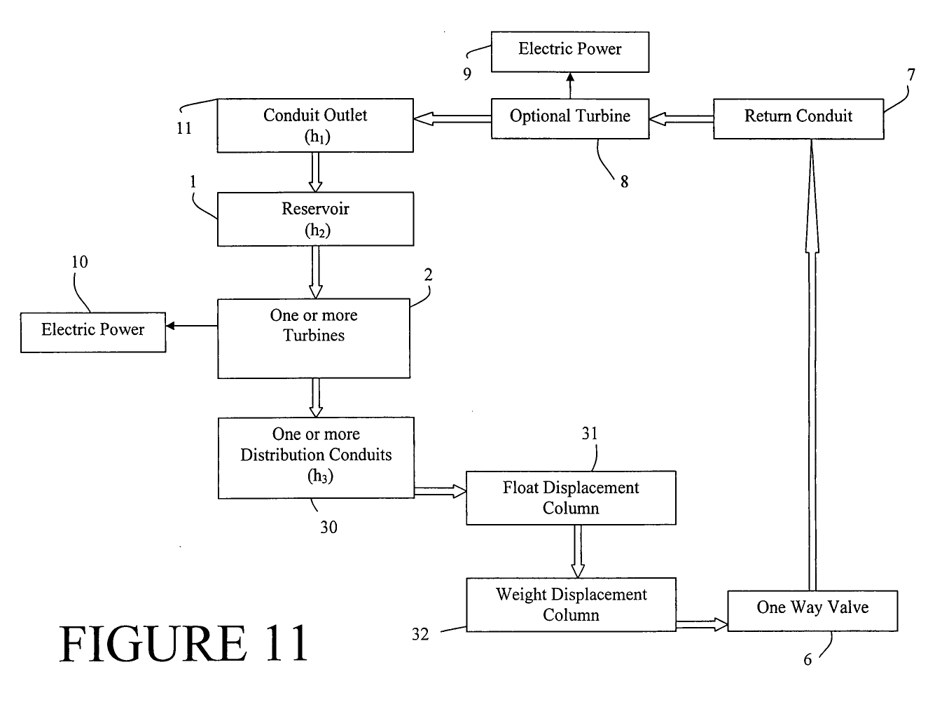

In one preferred embodiment of the present invention shown in FIG. 11, a distribution tank is not required. Like the systems in FIG. 9 and FIG. 10, the system includes a circulating liquid, one or more reservoirs, one or more weights, and one or more floatation devices. Rather than exiting the reservoir 1 to a distribution tank, the reservoir 1 has at least one or more outlets that transport the circulating liquid in one or more distribution conduits 3 to one or more float displacement columns 31 then to one or more weight displacement columns 32. The one or more distribution conduits 3 include at least one or more turbines 2 that the circulating liquid turn to generate electric power 10. When the liquid enters the one or more float displacement columns 31, the system is similar to the embodiments in FIG. 9 and FIG. 10, and used a float, weight, and valve system to force water out of the two columns, through a one-way valve 6 into a return conduit 7 with an optional turbine 8 to generate power 9, through an outlet 11 and back into the reservoir 1.

The system displayed in FIGS. 12 through 15 is similar to the system displayed in FIGS. 4 through 7, with the exception of utilizing separate displacement columns for floats and weights, and the fact that these new embodiments do not involve engagement and disengagement of the floats and corresponding weights. In FIGS. 4 through 7, the system includes a plurality of displacement columns 4 that each contains at least one weight 23 and float 22 connected by some mechanism 24. In FIGS. 12 through 15 the system includes a plurality of float displacement columns 31 and a plurality of weight displacement columns 32 connected by at least one valve 33. The system includes a mechanism 39 that connects a float 22 and a weight 23 within the two columns. In each system, the liquid follows an identical path until it exits the distribution tank 3 and passes through the valve 27 and continues to follow an identical path once the liquid passes through the one way valve 6.

Both systems shown FIGS. 4 through 7 and systems shown in FIGS. 12 through 15 include valves. Each valve may be connected to the control system 28 that may open and close the valves at predetermined increments for a predetermined amount of time. Each valve may be controlled by, but is not limited to, the control system 28 via a remote control, a pre-programmed timer, a computerized system, or any combination thereof.

Although some the outlets in FIGS. 4 through 7 and FIGS. 12 through 15 are shown to end above the circulating liquid and some below, the figures do not restrict the design. Each of the outlets may end either above, below, or at an equal level with the circulating liquid.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

For example, the present invention has been described in accordance with the Summary and the description of the drawings without specific mechanical or physical details. Any functional design of the present invention systems may be used and are within the skills of the artisan. For example, the conduits could be metal or plastic piping and could include natural or man-made viaducts; the displacement columns could be tanks of any footprint shape, including but not limited to circle, square, rectangle, ellipse, or polygon. The floats may be foam, airbags, closed containers such as metal or plastic drums or may be balloons made of heavy duty fabric with air or lighter than air gasses and may be permanently inflated or cyclically inflated and deflated.

The present invention systems may include natural or man-made supplementive features, such as natural lakes or ponds as system reservoirs. Auxiliary pumps that may be solar powered or otherwise powered may be included for priming, supplementing, regulating, backing up, or otherwise assisting the present invention systems to move fluids from levels below the reservoir to the return conduit outlet or to the reservoir.

The hydro turbines utilized in present invention systems may be positioned at any location where they will function effectively and in those embodiments where there are separate float displacement columns and weight displacement columns, one or more hydro turbines may be located between these two different columns, as well as other positions shown or described above.

As mentioned above, the present invention systems use a plurality of displacement columns, and at least two are necessary to minimize down time or idol time (no hydro turbines being driven), but much like a automobile engine where at least four cylinders make for a smooth drive, at least four displacement columns are utilized in some embodiments. However in some embodiments, tens or hundreds of displacement columns may be included within the scope of the present invention. Also the floats and weights are described generally as one float for each weight. However, some present invention systems could have two, three, or more floats for each weight. These plural floats for a single weight may operate in separate or the same tanks and could operate in series or in parallel and could include float displacement columns at different elevations so as to include cascading fluid flow to increase any lift capacity of the system and/or provide structural design options.

What is claimed is:

1. A hydropower system with reciprocal floatation device for generating electric power, which compromises:
a physical structure establishing a circuitous loop for flow of liquid that includes a liquid for circulating in said loop, an upper level, an upper midlevel and a lower midlevel and a lower level, said physical structure including components as follows:
a) a liquid return conduit having a conduit outlet at said upper level;
b) at least one reservoir located below said conduit outlet, said at least one reservoir being located between said upper level and said lower level, and having liquid dispensing means for dispensing said liquid from said at least one reservoir to a plurality of displacement columns;
c) said plurality of displacement columns, each displacement column being located functionally below said reservoir liquid dispensing means;
d) at least one electric power producing hydro turbine located within said loop and upstream from said plurality of displacement columns;
e) control means and valve means connected to said reservoir liquid dispensing means and said displacement column for sequentially adding and removing liquid to and from said displacement column for upward floatation of at least one weight and corresponding float for subsequent removal of liquid from said displacement column via gravitational force of said weight;
f) a weight positioned within each of said displacement columns and arranged therein to reciprocally move up and down and to seal liquid under it at least during downward travel within said displacement column;
g) a float connected to each said weight, said float having sufficient buoyancy to lift said weight;
h) means for engaging said float to said weight for upward movement of said float and weight in rising liquid and disengagement of said float from said weight for removal of liquid from said displacement column via gravitational force of said weight;
wherein, said weight and float have a reciprocal cycle having four positions, said four positions being: a first position with liquid rising, a second position with liquid at its maximum capacity, a third position with liquid releasing, and a fourth position with liquid at its lowest capacity, such that when said liquid is at its lowest capacity the disengaged weight and float engage, when said liquid rises, the engaged weight and float rise in the displacement column, when said liquid is at its maximum capacity the engaged weight and float disengage, and when said liquid is releasing the disengaged weight travels downward via gravity displacing the liquid from said displacement column through the appropriate valve means to said liquid return conduit with said conduit outlet at the upper level, completing a circuitous loop and driving said at least one electric producing power hydro turbine.

2. The hydropower system with reciprocal floatation device for generating electric power of claim 1 wherein said system valve means includes at least a first valve and a second valve, wherein said first valve is located at said at least one reservoir liquid dispensing means and is functionally connected to said control means to control liquid flow from said reservoir to at least one of said plurality of displacement columns, and said second valve is a one way valve located between at least one displacement column and said liquid return conduit to permit liquid to flow from said at least one displacement column to said liquid return conduit and not vice versa.

3. The hydropower system with reciprocal floatation device for generating electric power of claim 1 wherein said system includes four displacement columns, and four corresponding liquid dispensing means, four weights, four floats, four means for engaging and disengaging a float to a weight and four first valves and four second valves.

4. The hydropower system with reciprocal floatation device for generating electric power of claim 3 wherein each of said four weights and four floats are in different of said first position, and second position, said third position and said fourth position of its reciprocal cycle during operation thereof.

5. The hydropower system with reciprocal floatation device for generating electric power of claim 1 wherein said at least one electric power producing hydro turbine is positioned between said reservoir and said plurality of displacement columns.

6. The hydropower system with reciprocal floatation device for generating electric power of claim 1 wherein the system further includes a distribution tank for distributing liquid to said plurality of displacement columns, and wherein said return conduit is located at said upper level, said reservoir is located at said upper midlevel, said distribution tank is located at said lower midlevel and said plurality of displacement columns is located at said lower level.

7. The hydropower system with reciprocal floatation device for generating electric power of claim 6 wherein said system valve means includes at least a first valve and a second valve, wherein said first valve is located at said at least one reservoir liquid dispensing means and is functionally connected to said control means to control liquid flow from said reservoir to at least one of said plurality of displacement columns, and said second valve is a one way valve located between at least one displacement column and said liquid return conduit to permit liquid to flow from said at least one displacement column to said liquid return conduit and not vice versa.

8. The hydropower system with reciprocal floatation device for generating electric power of claim 6 wherein said system includes four displacement columns, and four corresponding liquid dispensing means, four weights, four floats, four means for engaging and disengaging a float to a weight and four first valves and four second valves.

9. The hydropower system with reciprocal floatation device for generating electric power of claim 8 wherein each of said four weights and four floats are in different of said first position, and second position, said third position and said fourth position of its reciprocal cycle during operation thereof.

10. The hydropower system with reciprocal floatation device for generating electric power of claim 6 wherein said at least one electric power producing hydro turbine is positioned between said reservoir and said plurality of displacement columns.

11. A hydropower system with reciprocal floatation device for generating electric power, which compromises:
a physical structure establishing a circuitous loop for flow of liquid that includes a liquid for circulating in said loop, an upper level, an upper midlevel and a lower midlevel and a lower level, said physical structure including components as follows:
a) a liquid return conduit having a conduit outlet at said upper level;
b) at least one reservoir located below said conduit outlet, said at least one reservoir being located between said upper level and said lower level, and having liquid dispensing means for dispensing said liquid from said at least one reservoir to a plurality of float displacement columns;
c) said plurality of float displacement columns, each float displacement column being located functionally below said reservoir liquid dispensing means;
d) a plurality of weight displacement columns located below said plurality of float displacement columns;
e) at least one electric power producing hydro turbine located within said loop and upstream from said plurality of displacement columns;
f) control means and valve means connected to said reservoir liquid dispensing means and said float displacement columns for sequentially adding and removing liquid to and from said float displacement columns and said weight displacement columns for upward floatation of at least one weight and corresponding float for subsequent removal of liquid from said displacement column via gravitational force of said weight;
g) a weight positioned within each of said weight displacement columns and arranged therein to reciprocally move up and down and to seal liquid under it at least during downward travel within said weight displacement column;
h) a float connected to each said weight, said float being within said float displacement columns and having sufficient buoyancy to lift said weight;
i) means for sequentially filling said float displacement columns to raise said float and said weight, holding said float at a float displacement columns liquid filled position, moving said liquid from said float displacement columns to said weight displacement columns, releasing said float and connected weight, so as to permit said weight to remove liquid from said weight displacement columns to said liquid return conduit via gravitational force of said weight;
wherein said weight and float have a reciprocal cycle having four positions, said four positions being: a first position with liquid rising in said float displacement columns and said float lifting said weight, a second position with liquid at its maximum capacity in said float displacement columns wherein one of said float and said weight is held to hold said weight in an elevated position in said weight displacement columns, a third position with liquid releasing from said float displacement columns to said weight displacement columns to fill said weight displacement columns with liquid up to said weight, and fourth position with said float released and said weight removing liquid from said weight displacement columns caused by said weight traveling downward via gravity and displacing the liquid from said weight displacement columns through the appropriate valve means to said liquid return conduit with said conduit outlet at the upper level, completing a circuitous loop and driving said at least one electric producing power hydro turbine.

12. The hydropower system with reciprocal floatation device for generating electric power of claim 11 wherein said system valve means includes at least a first valve and a second valve, wherein said first valve is located at said at least one reservoir liquid dispensing means and is functionally connected to said control means to control liquid flow from said reservoir to at least one of said plurality of float displacement columns, and said second valve is a one way valve located between at least one weight displacement column and said liquid return conduit to permit liquid to flow from said at least one weight displacement column to said liquid return conduit and not vice versa.

13. The hydropower system with reciprocal floatation device for generating electric power of claim 11 wherein said system includes four float displacement columns and weight displacement columns, and four corresponding liquid dispensing means, four weights, four floats, and four first valves and four second valves.

14. The hydropower system with reciprocal floatation device for generating electric power of claim 13 wherein each of said four weights and four floats are in different of said first position, and second position, said third position and said fourth position of its reciprocal cycle during operation thereof.

15. The hydropower system with reciprocal floatation device for generating electric power of claim 11 wherein said at least one electric power producing hydro turbine is positioned between said reservoir and said plurality of displacement columns.

16. The hydropower system with reciprocal floatation device for generating electric power of claim 11 wherein the system further includes a distribution tank for distributing liquid to said plurality of float displacement columns, and wherein said return conduit is located at said upper level, said reservoir is located at said upper midlevel, said distribution tank is located at said lower midlevel and said plurality of float displacement columns is located at said lower level with said weight displacement columns located below said float displacement columns.

17. The hydropower system with reciprocal floatation device for generating electric power of claim 16 wherein said system valve means includes at least a first valve and a second valve, wherein said first valve is located at said at least one reservoir liquid dispensing means and is functionally connected to said control means to control liquid flow from said reservoir to at least one of said plurality of float displacement columns, and said second valve is a one way valve located between at least one weight displacement column and said liquid return conduit to permit liquid to flow from said at least one weight displacement column to said liquid return conduit and not vice versa.

18. The hydropower system with reciprocal floatation device for generating electric power of claim 16 wherein said system includes four float displacement columns and four weight displacement columns, and four corresponding liquid dispensing means, four weights, four floats, and four first valves and four second valves.

19. The hydropower system with reciprocal floatation device for generating electric power of claim 18 wherein each of said four weights and four floats are in different of said first position, and second position, said third position and said fourth position of its reciprocal cycle during operation thereof.

20. The hydropower system with reciprocal floatation device for generating electric power of claim 16 wherein said at least one electric power producing hydro turbine is positioned between said reservoir and said plurality of float displacement columns.
